(19) United States
(12) Patent Application Publication
(10) Pub. No.: US 2006/0279501 A1
(43) Pub. Date: Dec. 14, 2006

(54) Bi-stable chiral nematic liquid crystal display and driving method for the same

(75) Inventors: Chih-Chiang Lu, Hsinchu County (TW); Chung-Yi Chang, Hsinchu County (TW); Chi-Chang Liao, Hsinchu County (TW); Chen-Pang Kung, Hsinchu County (TW)

Correspondence Address: BACON & THOMAS, PLLC, 625 SLATERS LANE, FOURTH FLOOR, ALEXANDRIA, VA, 22314, US

(73) Assignee: Industrial Technology Research Institute, Hsin Chu (TW)

(21) Appl. No.: 11/207,818

(22) Filed: Aug. 22, 2005

(30) Foreign Application Priority Data
Jun. 8, 2005 (TW) 94118898

(51) Int. Cl. G09G 3/36

(52) U.S. Cl. 345/94

(57) ABSTRACT

The present invention provides a bi-stable chiral nematic liquid crystal display and a driving method for the same. Each pixel of the liquid crystal display includes at least a transistor as a switch element to switch a column voltage to the pixel and a capacitor for storing a voltage of the pixel. The method for driving the bi-stable chiral nematic liquid crystal display is to divide each frame to be updated into a plurality of sub-frames. During a period of each sub-frame, the bi-stable chiral nematic liquid crystal is driven to a corresponding state in accordance with a respective driving condition.

### BACKGROUND OF THE INVENTION

1. Field of the Invention

The present invention relates to a bi-stable chiral nematic liquid crystal display and a method for driving the same; and more particularly to an active matrix bi-stable chiral nematic liquid crystal display.

2. Description of the Related Art

Cholesteric liquid crystal material is a reflective material that provides an additive colored gray-scale image. The material with bi-stable property has a very wide viewing angle by way of proper design and does not require additional elements such as polarizers and color filters etc. Therefore, the material can provide a low power consumption and low cost display with high resolution and good colorful image quality. Cholesteric materials have two stable states of planar state and focal conic state. The Planar (P) state is a reflective state of the material, and is stable with zero applied electrical field. The Focal Conic (Fc) state is a scattering state of the material, and is also stable with zero applied electrical field. Another non-stable state called Homeotropic (H) state is capable of vertically aligned at the applied voltage above a threshold voltage, for example 30V, and behaves optically transparent. An instable state also exists, which can occur in the beginning of relaxation process from the H state. This is called the Transient Planar (P*) state. This state only arises if the high voltage on the material in the H state is reduced to zero voltage rapidly, for example 2 ms or less. The Transient Planar state can relaxes to the Planar (P) state in the absence of applied voltage. Both Homeotropic and Transient Planar states can serve as immediate states for state transition.

In application of Cholesteric liquid crystal material, many drive schemes switching between the Planar state and Focal conic state have been developed. The conventional bi-stable chiral nematic liquid crystal display employs a direct drive method for driving the segment pixels or a multiplex drive method for the passive matrix pixels to display the image. For many years, to attain rapid drive effect, there are several drive schemes utilizing the particular properties of the cholesterol chiral nematic liquid crystal have been developed. For example, U.S. Pat. No. 5,748,277, entitled “Dynamic Drive Method and Apparatus for a Bi-stable Liquid Crystal Display”, provides a dynamic drive method. U.S. Pat. No. 6,204,835, entitled “Culmulative Two Phase Drive Scheme for Bi-stable Cholesteric Reflective display”, provides a culmulative drive method. However, due to the limitation of the drive of the passive matrix liquid crystal display, it is not easy to improve the resolution, dynamic frame, and display quality of the bi-stable chiral nematic liquid crystal display.

Moreover, U.S. Pat. No. 6,703,995, entitled “Bi-stable Chiral Nematic Liquid Crystal Display and Method of Driving The Same”, assigned to Koninklijke Philips Electronics N.V., provides a dynamic drive method for driving the active matrix bi-stable chiral nematic liquid crystal display. For attaining the particular waveforms of the dynamic drive method, U.S. Pat. No. 6,703,995 employs a 5T1C pixel architecture. And, for controlling transistors of the 5T1C pixel architecture, many control signals are required. As such, the manufacturing cost of the drive system is increased, the pixel architecture is complicated and the manufacturing yield is lowered. The pixel architecture is also provided with many transistors and capacitors so as to reduce the aperture ratio of the pixels. The display quality is adversely influenced.

Another U.S. Pat. No. 6,052,103, entitled “Liquid-Crystal Display Device and Driving Method Thereof:, assigned to Kabushiki Kaisha Toshiba, provides 1T1C pixel architecture, however, its driving scheme using multiple driving pulses during an addressing line results in time consumption. Each driving pulse contains minimum state transition time or relaxation time which is much time consumed for multiplexing driving and makes the image switching rate too high to show the video pictures.

### SUMMARY OF THE INVENTION

It is one objective of the present invention to provide a bi-stable chiral nematic liquid crystal display possibly employing a 1T pixel architecture, which eliminates the elements of the pixel and the manufacturing cost and improves manufacturing yield. The aperture ratio of the pixel is increased and the quality of display is improved:

It is a further objective of the present invention to provide a method for actively driving a bi-stable chiral nematic liquid crystal display, which divides a frame to be updated into a plurality of sub-frames which respectively corresponding to specific driving waveforms such that the bi-stable chiral nematic liquid crystal is driven to a specific state correspondingly thereto.

According to the above objectives, the present invention provides a bi-stable chiral nematic liquid crystal display and a method for driving the same. The bi-stable chiral nematic liquid crystal display includes a first substrate having a first surface; a plurality of row electrodes and a plurality of column electrodes formed on the first surface of the substrate in a matrix form; a second substrate having a second surface opposite to the first surface; a common electrode formed on the second surface of the second substrate such that the common electrode is opposite to the row electrodes and column electrodes; a bi-stable chiral nematic liquid crystal layer sealed between the first substrate and second substrate, wherein a portion of the bi-stable chiral nematic liquid crystal layer corresponding to an intersection of each of the row electrodes and each of the column electrode forms a pixel, the pixel forms a pixel capacitor, and one end of the pixel capacitor is connected to the common electrode and the other end of the pixel capacitor forms a pixel electrode; a plurality of scan lines formed on the first surface of the first substrate, each of the scan lines corresponds to a row of the row electrodes; a plurality of data lines formed on the first surface of the first substrate, each of the data lines corresponds to a column of the column electrodes; at least one switch element formed on an intersection of each of the row electrodes and each of the column electrodes to serve as a drive switch of the corresponding pixel, the switch element including a conducting path and a control terminal for controlling electrical conductance of the conductance path, the control terminal connected to one of the scan lines corresponding thereto, the conducting path including a first terminal and a second terminal, the first terminal connected to one of the data lines and the second terminal connected to one of the pixel electrodes; a scan line driver for providing at least a scan line signal to each of the scan lines; a data line driver for providing at least a data signal to each of the data lines; and a graphic controller for storing and processing graphic information, the graphic controller sending the graphic information to the data line driver and controlling the data line driver to output a voltage signal, simultaneously sending a control signal to control the scan line driver to send a scan signal, and at the same time, sending another control signal to a voltage source to control the voltage source to output a voltage to control an applied voltage of each of the pixels. In the present invention, each frame of the display is divided into a first sub-frame, a second sub-frame and a third sub-frame, the applied voltage of each of the pixels of the first sub-frame and the second sub-frame is a constant voltage, and the applied voltage of each of the pixels is determined by the graphic information, the constant voltages of the first sub-frame and the second sub-frame are provided by the voltage source, and the applied voltage of each of the pixels of the second sub-frame is provided by the data line driver.

In one another aspect, each frame of the present display can be divided into a first sub-frame and a second sub-frame. The applied voltage of the pixel of the second sub-frame is a constant voltage and the applied voltage of the pixel of the first sub-frame is determined by the graphic information to be written in. The constant voltage of the second sub-frame is provided by the voltage source and the applied voltage of the pixel of the first sub-frame is provided by the data line driver.

The method for driving the present bi-stable chiral nematic liquid crystal display is to divide a frame to be updated into a first sub-frame, a second sub-frame and a third sub-frame. The present method includes steps of: driving the first sub-frame to activate the bi-stable chiral nematic liquid crystal to Homeotropic states to eliminate memory information of the pixels; driving the second sub-frame to write updated information in the pixels; and driving the third sub-frame to zero down applied voltages of the pixels such that the bi-stable chiral nematic liquid crystal stays at states corresponding to the updated information.

In further one another aspect, the method for driving the present bi-stable chiral nematic liquid crystal display includes driving the first sub-frame to write the updated information in the pixels; and driving the second sub-frame to zero down the applied voltages of the pixels such that the bi-stable chiral nematic liquid crystal stays at states corresponding to the updated information.

In view of the foregoing, the present bi-stable chiral nematic liquid crystal display employs the 1T pixel architecture to realize the driving waveforms of the present invention so as to eliminate the components and manufacturing cost as well as improve the manufacturing yield. The aperture ratio of the pixels is increased and the quality of display is improved.

For compensating the voltage variation in the pixel capacitor, another capacitor called storage capacitor is introduced, which is designed to almost keep the writing voltage constant to minimize the voltage variation caused by the state change of liquid crystal which will result a different capacitance and then a corresponding voltage variation. This is a 1T1C architecture and popularly used in the active matrix (AM) liquid crystal display.

The purposes and many advantages of the present invention are illustrated by detailed description of the embodiment, and become clearer understood with reference to accompanying drawings.

### BRIEF DESCRIPTION OF THE DRAWINGS

FIG. 1 is a schematic driving circuit of the present bi-stable chiral nematic liquid crystal display according to a first embodiment;

FIG. 2A depicts applied voltages of the pixels corresponding to respective sub-frames when information of the Planar state is to be written;

FIG. 2B depicts applied voltages of the pixels corresponding to respective sub-frames when information of the Focal Conic state is to be written;

FIG. 3A depicts applied voltages of the pixels corresponding to respective sub-frames when the information of the Planar state is to be written by performing an inversion function;

FIG. 3B depicts applied voltages of the pixels corresponding to respective sub-frames when the information of the Focal Conic state is to be written by performing an inversion function;

FIG. 4A depicts applied voltages of the pixels corresponding to respective sub-frames when information of the Planar state is to be written in;

FIG. 4B depicts applied voltages of the pixels corresponding to respective sub-frames when information of the Focal Conic state is to be written in;

FIG. 5A depicts a timing diagram of driving waveforms when the information of the Planar state is to be written in;

FIG. 5B depicts a timing diagram of driving waveforms when the information of the Focal Conic state is to be written in;

FIG. 6A depicts a timing diagram of inversing driving waveforms when the information of the Planar state is to be written in; and

FIG. 6B depicts a timing diagram of inversing driving waveforms when the information of the Focal Conic state is to be written in.

### DETAILED DESCRIPTION OF THE PREFERRED EMBODIMENTS

The present invention provides a bi-stable chiral nematic liquid crystal display and a method for active matrix driving the same. Each pixel of the bi-stable chiral nematic liquid crystal display includes at least a transistor as a switch element for inputting a column voltage to the pixel. The pixel also includes a capacitor for storing the voltage of the pixel. The panel of the bi-stable chiral nematic liquid crystal display includes a pixel circuit for driving the display. A data signal enters a selector via a data bus and the selector selects one of input terminal signals formed of at least one constant voltage and one data signal as an output signal for driving the column voltage of the bi-stable chiral nematic liquid crystal. Meanwhile, a proper voltage is applied to the common electrode coupled to the other end of the pixels. As such, the bi-stable chiral nematic liquid crystal of the pixels is driven to a corresponding state.

More specifically, the pixel of the present bi-stable chiral nematic liquid crystal display is designed to have a 1T1C architecture. The 1T represents the least active element of the conventional active matrix liquid crystal display for serving as a switch element for addressing and non-addressing. The 1C is a passive element of the conventional active matrix liquid crystal display for stabilizing and adjusting the capacitance of the pixel so as to reduce the drift of the voltage of the pixel.

Moreover, the active drive method of the present bi-stable chiral nematic liquid crystal display is to divide a frame to be updated into a plurality of sub-frames each of which respectively corresponding to specific driving waveforms such that the bi-stable chiral nematic liquid crystal is driven to a corresponding state.

The present bi-stable chiral nematic liquid crystal display and the method for driving the same will be described in detail in accordance with the following embodiments with reference to accompanying drawings.

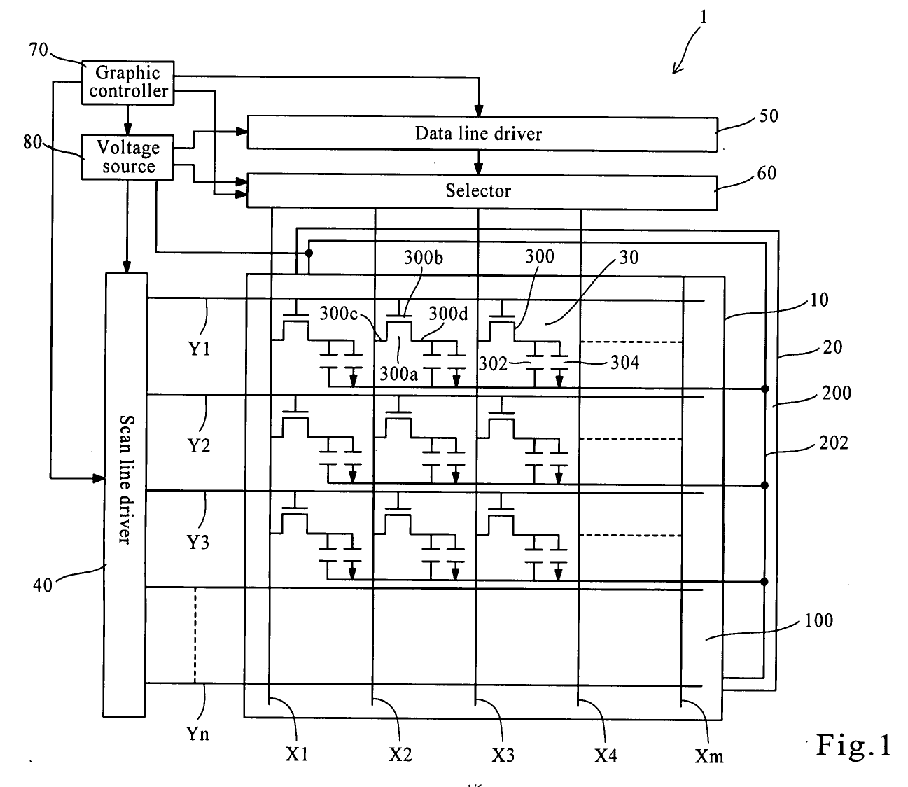

FIG. 1 is a schematic driving circuit of the present bi-stable chiral nematic liquid crystal display according to a first embodiment. In the first embodiment, the present bi-stable chiral nemtic liquid crystal display 1 includes a first substrate 10, a second substrate 20, a bi-stable chiral nematic liquid crystal layer (not shown), a plurality of row electrodes (not shown), a plurality of column electrodes (not shown), a common electrode 202, a plurality of scan lines Y1, Y2, Y3, . . . , Yn, a plurality of data lines X1, X2, X3, X4, . . . , Xm, a plurality of switch elements 300, a plurality of capacitor elements 304, a scan line driver 40, a data line driver 50, a selector 60, a graphic controller 70 and a voltage source 80. The first substrate 10 has a first surface 100. The row electrodes and column electrodes (not shown) are formed on the first surface 100 of the first substrate 10 in a matrix form. The second substrate 20 has a second surface opposite to the first surface 100. The common electrode 202 is formed on the second surface 200 of the second substrate 20 such that the common electrode 202 is opposite to the row electrodes and column electrodes. The bi-stable chiral nematic liquid crystal layer, for example cholesterol liquid crystal layer, is sealed between the first substrate 10 and the second substrate 20. A portion of the liquid crystal layer corresponding to an intersection of each of the row electrodes and each of the column electrodes forms a pixel 30. The pixel 30 forms a pixel capacitor 302. One end of the pixel capacitor 302 is connected to the common electrode 202 and the other end of the pixel capacitor 302 forms a pixel electrode. The scan lines Y1, Y2, Y3, . . . , Yn and the data lines X1, X2, X3, X4, . . . , Xm are formed on the first surface 100 of the first substrate 10 in a matrix form. Each of the scan lines corresponds to a row of the row electrodes and each of the data lines corresponds to a column of the column electrodes. Each of the switch elements 300, for example a transistor, is formed at the intersection of each of the row electrodes and each of the column electrodes, for serving as a driving switch of the pixel 30 corresponding thereto. The switch element 300 includes a conducting path 300a and a control terminal 300b for controlling conductivity of the conducting path 300a. The control terminal 300b is connected to one of the scan lines corresponding thereto. The conducting path 300a includes a first terminal 300c and a second terminal 300d. The first terminal 300c is connected to one of the data lines and the second terminal 300d is connected to one of the pixel electrodes corresponding thereto. The capacitor elements 304 are formed on the first surface 100 of the first substrate 10. Each of the capacitor elements 304 corresponds to one of the pixels 30. One end of the capacitor elements 304 is connected to one of the pixel electrodes corresponding thereto. The other end of the capacitor element 304 is grounded or connected to a positive or negative voltage. Both of the other end of the capacitor element 304 and the common electrode 202 can be connected to a negative voltage to reduce the highest voltage of the system and the bearing voltage of the switch element 300, i.e. the transistor, of the pixel 30 to maintain the stability of the property of the transistor. The capacitor element 304 stabilizes and adjusts the capacitance of the pixel 30 corresponding thereto to reduce the drift of the voltage of the pixel 30. The scan line driver 40 provides at least a scan signal to each of the scan lines. The data line driver 50 provides at least a data signal to each of the data lines. The selector 60 is connected to an output end of the data line driver 50 and the voltage source 80 as the input voltage and connected to the data lines X1, X2, X3, X4, . . . , Xm as the output voltage. A control signal is inputted to the selector 60 via a control pin (not shown) such that the selector 60 selects the input voltage provided by which of the voltage source 80 or the data line driver 50 relied upon the control signal. Then, the input voltage is conducted to the data lines X1, X2, X3, X4, . . . , Xm. The control signal of the selector 60 via the control pin is provided by the graphic controller 70. The voltage source 80 supplies respective voltages to the scan line driver 40, the data line driver 50, the selector 60 and the common electrode 202. The graphic controller 70 stores and processes graphic information and outputs the graphic information as well as controls the data line driver 50 to output a voltage signal corresponding thereto. In the meantime, the graphic controller 70 sends one control signal to the scan line driver 40 to control the scan line driver 40 to output a scan signal. Meanwhile, the graphic controller 70 sends another control signal to the voltage source 80 to control the voltage source 80 to output various desired voltages to control the applied voltage of each of the pixels.

In the first embodiment, the method for driving the present bi-stable chiral nematic liquid crystal display is to divide a frame to be updated into a plurality of sub-frames which are sequentially driven. Each of the sub-frames corresponds to specific driving conditions so as to drive the bi-stable chiral nematic liquid crystal to a corresponding state. For example, the frame of the display 1 to be updated is divided into a first sub-frame, a second sub-frame and a third sub-frame. During the period of the first sub-frame, the bi-stable chiral nematic liquid crystal is driven to the Homeotropic state, which is not a stable state. The purpose of which is to reset the information within the pixels to eliminate memory information of the pixels. During the second sub-frame, the updated information is written in the corresponding pixels. In case that the updated information is a single-color data, the updated information corresponds to a write-in bit. In the event that the updated information is gray-scale data, the updated information corresponds to a plurality of write-in bits. During the third sub-frames, the required voltage of the panel is zeroed down. That is, all the pixels are zeroed such that the power consumption of the display panel becomes zero. Due to the properties of the bi-stable chiral nematic liquid crystal itself, the bi-stable chiral nematic liquid crystal relaxed to the stable state corresponding to the write-in updated information, i.e. the stable state corresponding to the second sub-frame, after the third sub-frame is driven. Therefore, the applied voltages of the pixels of the first sub-frame and second sub-frame are respective constant voltages, and the applied voltage of the pixels of the second sub-frame is determined by the write-in updated information. The respective constant voltages of the first sub-frame and second sub-frame are provided by the voltage source 80. The applied voltage of the pixels of the second sub-frame is provided by the data line driver 50. In other words, the data voltages of the first sub-frame, second sub-frame and the third sub-frame are controlled by the selector 60.

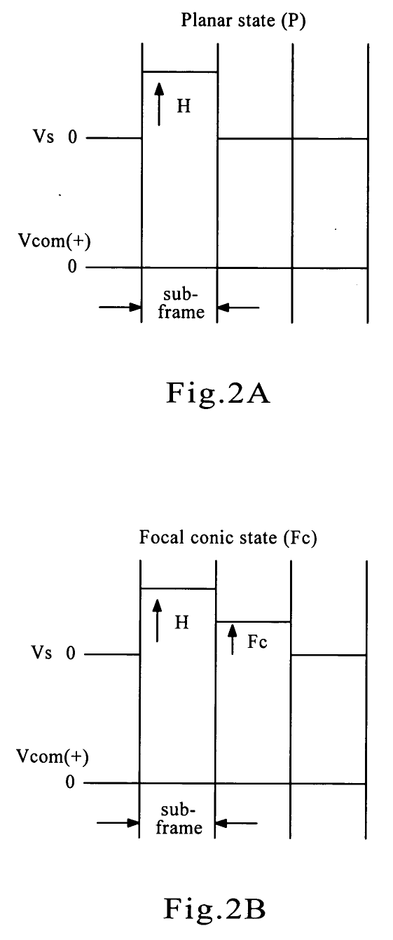

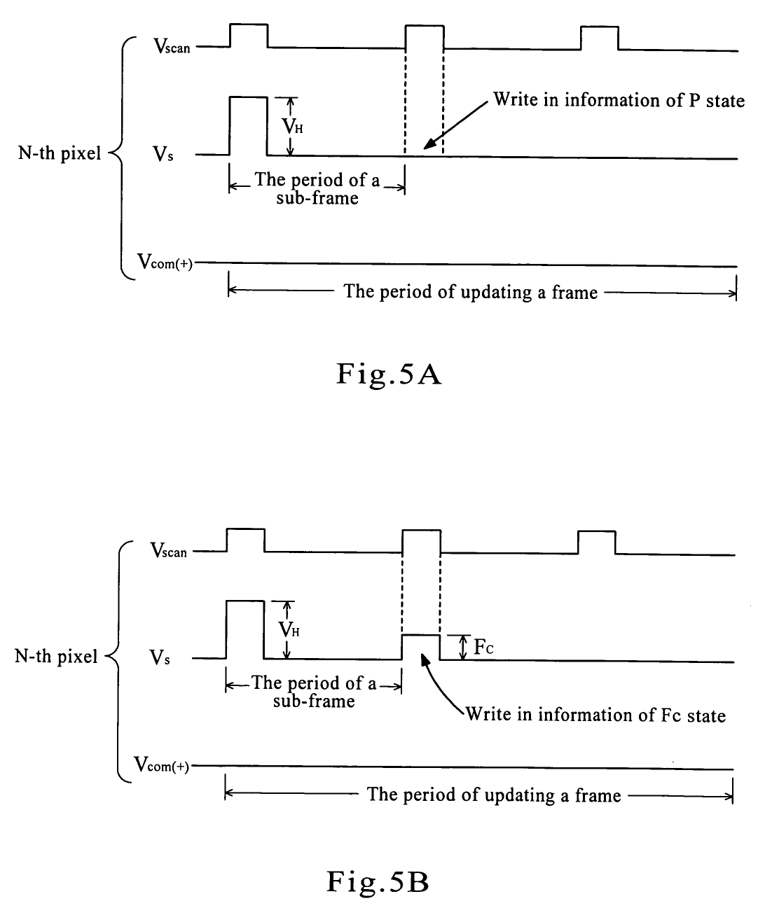

FIG. 2A depicts applied voltages of the pixels corresponding to the first sub-frame, second sub-frame and the third sub-frame when the information of the Planar state (P state) is to be written in. FIG. 5A is a timing diagram of the driving waveforms corresponding to FIG. 2A. Each frame of each of the pixels 30 is divided into three sub-frames. The scan lines Y1, Y2, Y3, . . . , Yn of each of the sub-frames are sequentially scanned to switch the transistors of the pixels 30, and at the same time, the data voltages are sequentially written in the pixels 30. More specifically, during the first sub-frame, the voltage source 80 supplies a constant voltage V_{H} to the selector 60, and the constant voltage V_{H} is conducted to all the data lines X1, X2, X3, X4, . . . , Xm via the selector 60 to supply the data voltage V_{H} to the driven pixels 30. During the first sub-frame, all the pixels 30 can be simultaneously driven to save time for updating the sub-frame. The voltage source 80 supplies zero voltage (0 Vcom) to the common electrode 202 during the first sub-frame, second sub-frame and the third sub-frame. Therefore, the applied voltage of the pixels 30 is V_{H} during the first sub-frame, and the bi-stable chiral nematic liquid crystal is driven to the Homeotropic state (H state). Next, during the second sub-frame, the data line driver 50 supplies zero voltage to the selector 60, and the zero voltage is conducted to the selected data line via the selector 60 to provide the data voltage to the corresponding pixels 30. During the second sub-frame, the scan line driver 40 drives the pixels 30 in a line-by-line way so as to write the updated information in the selected pixels 30. During the second sub-frame, the applied voltage of the pixels is zero volt, the bi-stable chiral nematic liquid crystal is driven to the Planar state (P state). During the third sub-frame, the voltage source 80 supplies zero volt to the selector 60, and the zero volt is conducted to all the data lines X1, X2, X3, X4, . . . , Xm via the selector 60 so as to provide zero-volt data voltage to the driven pixels 30. During the third sub-frame, the pixels 30 can be driven in the line-by-line manner or simultaneously driven to save time for updating the frame. During the third sub-frame, the maintaining voltage of the pixels 30 is zeroed down. That is, the maintaining voltage of the display panel is zero. As such, the display panel consumes no more power after the frame of the display panel is updated. When the maintaining voltage of the pixels 30 is zeroed during the third sub-frame, the bi-stable chiral nematic liquid crystal is relaxed to the Planar state corresponding to the write-in updated information of the second sub-frame.

FIG. 2B depicts applied voltages of the pixels corresponding to the first sub-frame, second sub-frame and the third sub-frame when the information of the Focal Conic state (Fc state) is to be written in. FIG. 5B is a timing diagram of the driving waveforms corresponding to FIG. 2B. The difference between FIG. 2B and FIG. 2A is the data line driver 50 supplies V_{Fc} volt to the selector 60 during the second sub-frame in FIG. 2B, and the V_{Fc} volt is conducted to the selected data lines via the selector 60 to provide the data voltage to the corresponding pixels 30. During the second sub-frame, the pixels 30 are driven in the line-by-line manner to write the updated information in the selected pixels 30. During the second sub-frame, the applied voltage of the pixels 30 is V_{Fc} volt, and the bi-stable chiral nematic liquid crystal is driven to the Focal Conic state (Fc state). During the first sub-frame and third sub-frame, the driving waveforms conducted to the data lines from the selector 60 and the method that the scan line driver 40 drives the pixels 30 are the same with FIG. 2A. Therefore, during the third sub-frame, the maintaining voltage of the display panel is zero, the bi-stable chiral nematic liquid crystal is relaxed to the Focal Conic state corresponding to the write-in updated information of the second sub-frame.

In one another aspect, the present bi-stable chiral nematic liquid crystal display 1 is also provided with an inversion function to maintain the stability of the property of the bi-stable chiral nematic liquid crystal. The inversion function is performed to inverse the write-in bits and/or change the driving voltage to maintain the same updated information to be written in the pixels 30.

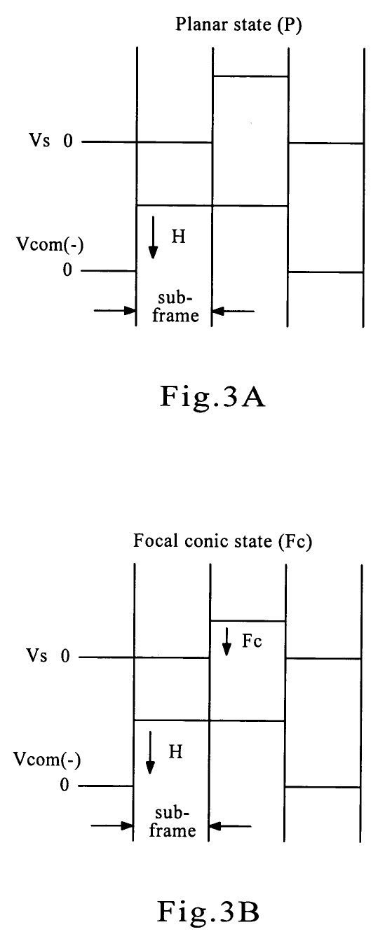

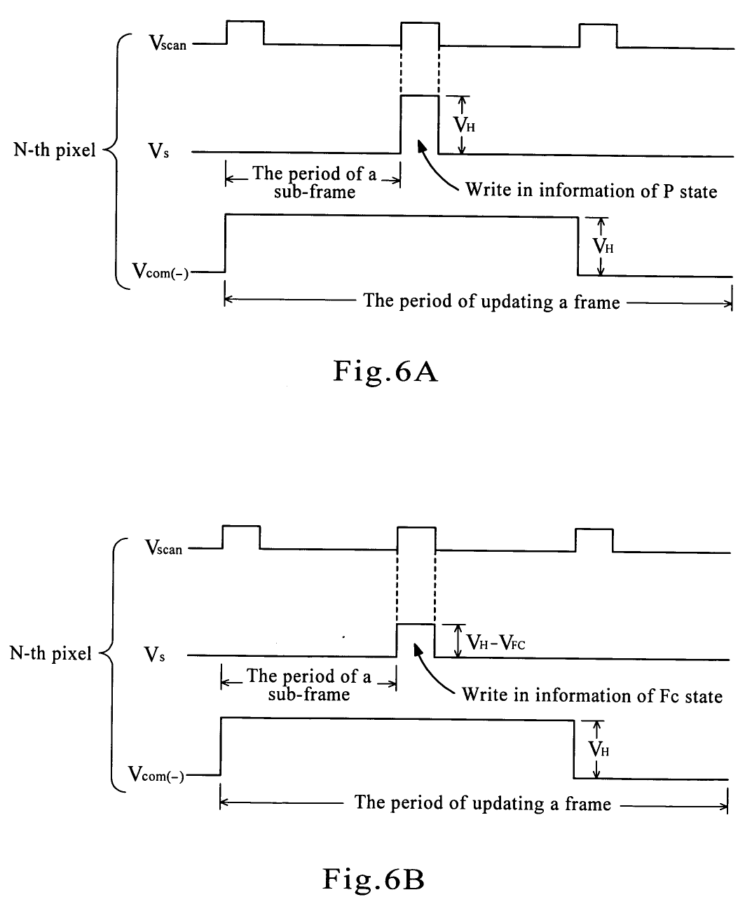

FIG. 6A depicts a timing diagram of the inversion driving waveforms corresponding to the first sub-frame, second sub-frame and the third sub-frame when the updated information corresponding to the Planar state is to be written in. FIG. 3A depicts applied voltages of the pixels corresponding to FIG. 6A. When the driving waveforms are inversed, the input voltages are changed. That is, the input voltage of the common electrode 202 is V_{H} during the first sub-frame and second sub-frame, and the voltage conducted to all the data lines X1, X2, X3, X4, . . . , Xm is zero volt during the first sub-frame such that the applied voltage of the pixels 30 is −V_{H}, and the bi-stable chiral nematic liquid crystal is driven to the Homeotropic state to reset the information of the pixels 30. During the second sub-frame, the voltage conducted to the selected data line is V_{H} volt. At this time, the applied voltage of the pixels is zero volt, and therefore the information of the Planar state is written in the corresponding pixels 30. During the third sub-frame, the input voltage of the common electrode 202 is zero volt and the voltage transmitted to all the data lines X1, X2, X3, X4, . . . , and Xm is zero volt. Therefore, the maintaining voltage of the pixels 30 is zero during the third sub-frame so as to reduce the power consumption of the display panel. And, the bi-stable chiral nematic liquid crystal is relaxed to the Planar state corresponding to the write-in updated information.

FIG. 6B depicts a timing diagram of inversion driving waveforms corresponding to the first sub-frame, second sub-frame and the third sub-frame when the information of the Focal Conic state is to be written in. FIG. 3B depicts applied voltages of the pixels corresponding to FIG. 6B. When the driving waveforms are inversed, the various input voltages are changed. That is, the input voltage of the common electrode 202 is V_{H} during the first sub-frame and second sub-frame. And, during the first sub-frame, the voltage conducted to all the data lines X1, X2, X3, X4, . . . , Xm is zero volt, and the applied voltage of the pixels is −V_{H} such that the bi-stable chiral nematic liquid crystal is driven to the Homeotropic state to reset the information of the pixels 30. During the second sub-frame, the voltage conducted to the selected data line is (V_{H}-V_{Fc}) volt, and at this time, the applied voltage of the pixels is −V_{Fc} Volt, the information of the Focal Conic state is written in the corresponding pixels 30. During the third sub-frame, the input voltage of the common electrode 202 is zero volt, and the voltage transmitted to all the data lines X1, X2, X3, X4, . . . , Xm is zero volt. Therefore, the maintaining voltage of the pixels is zero during the third sub-frame so as to reduce the power consumption of the display panel. The bi-stable chiral nematic liquid crystal is relaxed to the Focal Conic state corresponding to the write-in updated information.

In one another aspect, the frame of the display 1 to be updated can be divided into a first sub-frame and a second sub-frame which are sequentially driven. During the first sub-frame, the updated information is written in the pixels in the line-by-line manner. The applied voltage of the pixels is determined by the write-in updated information and provided by the data line driver 50. During the second sub-frame, the required voltage of the display panel is zero such that all the pixel electrodes are zero volt, and the power consumption of the display panel becomes zero. The applied voltage of the pixels is a constant voltage during the second sub-frame, which is provided by the voltage source 80. Moreover, during the second sub-frame, the pixels 30 can be driven in the line-by-line manner or simultaneously driven.

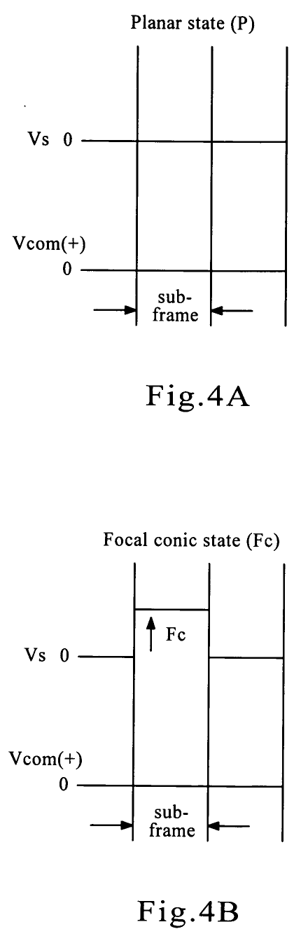

FIG. 4A depicts applied voltages of the pixels corresponding to the first sub-frame and second sub-frame when the information of the Planar state is to be written in. Comparing to the above three sub-frames driving scheme, the two sub-frame driving scheme is achieved by modifying the chiral nematic liquid crystal content and process to make the display change to the designated state without any refresh to eliminate any image sticking. The applied voltage of the pixels is zero volt during the first sub-frame and second sub-frame. FIG. 4B depicts applied voltages of the pixels corresponding to the first sub-frame and second sub-frame when the information of the Focal Conic state is to be written in. During the first sub-frame, the applied voltage of the pixels is Fc volt, and during the second sub-frame, the applied voltage of the pixels is zero volt.

Although the present invention has been described in considerable detail with reference to certain preferred embodiments thereof, those skilled in the art can easily understand that all kinds of alterations and changes can be made within the spirit and scope of the appended claims. Therefore, the spirit and scope of the appended claims should not be limited to the description of the preferred embodiments contained herein

What is claimed is:

1. A method for driving a bi-stable chiral nematic liquid crystal display, by which each frame of said liquid crystal display is divided into a first sub-frame, a second sub-frame and a third sub-frame, said method comprising:
driving said first sub-frame to activate bi-stable chiral nematic liquid crystal to homeotropic states to eliminate memory information of pixels;
driving said second sub-frame to write updated information in said pixels; and
driving said third sub-frame to zero down applied voltages of said pixels such that said bi-stable chiral nematic liquid crystal stays at states corresponding to write in said updated information.

2. The method as defined in claim 1, wherein the step for driving said first sub-frame includes simultaneously driving the whole of said first sub-frame.

3. The method as defined in claim 1, wherein the step for driving said third sub-frame includes simultaneously driving the whole of said third sub-frame.

4. The method as defined in claim 1, wherein the step for driving said second sub-frame includes sequentially writing in the updated information by scanning said second sub-frame.

5. The method as defined in claim 1, wherein the step for driving said third sub-frame includes zeroing down the applied voltages of said pixels by scanning said second sub-frame.

6. The method as defined in claim 1, wherein the write-in updated information of said second sub-frame is a one-bit data.

7. The method as defined in claim 1, wherein the write-in updated information of said second sub-frame is multi-bit data.

8. A method for driving a bi-stable chiral nematic liquid crystal display, by which each frame of said liquid crystal display is divided into a first sub-frame and a second sub-frame, said method comprising:
driving said first sub-frame to write updated information in pixels; and
driving said second sub-frame to zero down applied voltages of said pixels such that bi-stable chiral nematic liquid crystal stays at states corresponding to write in said updated information.

9. The method as defined in claim 8, wherein the step for driving said first sub-frame includes sequentially writing in the updated information by scanning said first sub-frame.

10. The method as defined in claim 8, wherein the step for driving said second sub-frame includes zeroing down the applied voltages of said pixels by scanning said second sub-frame.

11. The method as defined in claim 8, wherein the step for driving said second sub-frame includes simultaneously driving the whole of said second sub-frame.

12. The method as defined in claim 1, further comprising performing an inversion function to keep the same updated information to write in said pixels by inversing writing-in bits or changing driving voltages.

13. The method as defined in claim 8, further comprising performing an inversion function to keep the same updated information to write in said pixels by inversing writing-in bits or changing driving voltages.

14. The method as defined in claim 1, wherein bi-stable chiral nematic liquid crystal includes cholesterol liquid crystal molecules.

15. The method as defined in claim 8, wherein bi-stable chiral nematic liquid crystal includes cholesterol liquid crystal molecules.

16. A bi-stable chiral nematic liquid crystal display device, comprising:
a first substrate having a first surface;
a plurality of row electrodes and a plurality of column electrodes formed on said first surface of said substrate in a matrix form;
a second substrate having a second surface opposite to said first surface;
a common electrode formed on said second surface of said second substrate such that said common electrode is opposite to said row electrodes and said column electrodes;
a bi-stable chiral nematic liquid crystal layer sealed between said first substrate and said second substrate, wherein a portion of said bi-stable chiral nematic liquid crystal layer corresponding to an intersection of each said row electrode and each said column electrode forms a pixel, said pixel forms a pixel capacitor, and one end of said pixel capacitor is connected to said common electrode and the other end of said pixel capacitor forms a pixel electrode;
a plurality of scan lines formed on said first surface of said first substrate, each of said scan lines corresponds to a row of said row electrodes;
a plurality of data lines formed on said first surface of said first substrate, each of said data lines corresponds to a column of said column electrodes;
at least one switch element formed on an intersection of each said row electrode and each said column electrode to serve as a drive switch of said corresponding pixel, said switch element including a conducting path and a control terminal for controlling electrical conductivity of said conducting path, said control terminal connected to one said scan line corresponding thereto, said conducting path including a first terminal and a second terminal, said first terminal connected to one said data line and said second terminal connected to one said pixel electrode;
a scan line driver for providing at least a scan line signal to each said scan line;
a data line driver for providing at least a data signal to each said data line; and
a graphic controller for storing and processing graphic information, said graphic controller sending said graphic information to said data line driver and controlling said data line driver to output at least one voltage signal, simultaneously sending a control signal to control said scan line driver to send a scan signal, and at the same time, sending another control signal to a voltage source to control said voltage source to output a voltage to determine an applied voltage of each said pixel;
wherein each frame of said display is divided into a first sub-frame, a second sub-frame and a third sub-frame, said applied voltage of each said pixel of said first sub-frame and said third sub-frame is a constant voltage, and said applied voltage of each said pixel of said second sub-frame is determined by writing in said graphic information, said constant voltages of said first sub-frame and said second sub-frame are provided by said voltage source, and said applied voltage of each said pixel of said second sub-frame is provided by said data line driver.

17. The device as defined in claim 16, further comprising a plurality of capacitor elements formed on said first surface of said first substrate, each said capacitor element corresponding to one said pixel, one end of said capacitor element connected to one said pixel electrode corresponding thereto.

18. A bi-stable chiral nematic liquid crystal display, comprising:
a first substrate having a first surface;
a plurality of row electrodes and a plurality of column electrodes formed on said first surface of said first substrate in a matrix form;
a second substrate having a second surface opposite to said first surface;
a common electrode formed on said second surface of said second substrate such that said common electrode is opposite to said row electrodes and said column electrodes;
a bi-stable chiral nematic liquid crystal layer sealed between said first substrate and said second substrate, wherein a portion of said liquid crystal layer corresponding to an intersection of each said row electrode and each said column electrode forms a pixel, said pixel forms a pixel capacitor, one end of said pixel capacitor is connected to said common electrode and the other end of said pixel capacitor forms a pixel electrode;
a plurality of scan lines formed on said first surface of said first substrate, each said scan line corresponding to a row of said row electrodes;
a plurality of data lines formed on said first surface of said first substrate, each said data line corresponding to a column of said column electrodes;
at least a switch element formed on the intersection of each said row electrode and each said column electrode to serve as a switch element of said pixel, said switch element including a conductance path and a control terminal for controlling electrical conductance of said conductance path, said control terminal connected to one said scan line corresponding thereto, said conductance path including a first terminal and a second terminal, said first terminal connected to one said data line and said second terminal connected to one said pixel electrode;
a scan line driver for providing at least a scan signal to each said scan line;
a data line driver for providing at least a data signal to each said data line; and
a graphic controller for storing and processing graphic information, said graphic controller sending the graphic information to said data line driver to control said data line driver to output a voltage signal, simultaneously sending a control signal to said scan line driver such that said scan line driver outputs a scan signal, and at the same time, sending another control signal to a voltage source such that said voltage source outputs a voltage to determine the applied voltage of each said pixel;
wherein said frame of said display is divided into a first sub-frame and a second sub-frame, the applied voltage of each said pixel of said second sub-frame is a constant voltage, and the applied voltage of each said first pixel is determined by writing in the graphic information, the constant voltage of said second sub-frame is provided by said voltage source, and the applied voltage of each said pixel of said first sub-frame is provided by said data signal driver.

19. The device as defined in claim 18, further comprising a plurality of capacitor elements formed on said first surface of said first substrate, each said capacitor element corresponding to one said pixel, one end of said capacitor element connected to one said pixel electrode corresponding thereto.

20. The device as defined in claim 16, wherein said switch element includes a transistor.

21. The device as defined in claim 18, wherein said switch element includes a transistor.

22. The device as defined in claim 16, wherein said bi-stable chiral nematic liquid crystal layer includes cholesterol liquid crystal molecules.

23. The device as defined in claim 18, wherein said bi-stable chiral nematic liquid crystal layer includes cholesterol liquid crystal molecules.

24. The device as defined in claim 16, wherein said voltage source provides respective voltages to said data line driver, said scan line driver and said common electrode.

25. The device as defined in claim 18, wherein said voltage source provides respective voltages to said data line driver, said scan line driver and said common electrode.

26. The device as defined in claim. 16, wherein further comprises a voltage selector connected to an output terminal of said data line driver and said voltage source that serve as voltage input and connected to said data line that serve as voltage output, said selector selects an input voltage and conducts to said data lines depending on a control signal inputted via a control pin.

27. The device as defined in claim 18, wherein further comprises a voltage selector connected to an output terminal of said data line driver and said voltage source that serve as voltage input and connected to said data line that serve as voltage output, said selector selects an input voltage and conducts to said data lines depending on a control signal inputted via a control pin.

28. The device as defined in claim 26, wherein said control signal via said control pin is provided by said graphic controller.

29. The device as defined in claim 27, wherein said control signal via said control pin is provided by said graphic controller.
